(19) United States
(12) Patent Application Publication
(10) Pub. No.: US 2025/0200414 A1
(43) Pub. Date: Jun. 19, 2025

(54) QUANTUM OBJECT CONFINEMENT APPARATUS

(71) Applicant: Quantinuum LLC, Broomfield, CO (US)

(72) Inventors: Thomas Richard MARKHAM, Fridley, MN (US); Robert HORNING, Broomfield, CO (US)

(21) Appl. No.: 18/930,425

(22) Filed: Oct. 29, 2024

Related U.S. Application Data
(60) Provisional application No. 63/609,764, filed on Dec. 13, 2023.

(51) Int. Cl. G06N 10/40

(52) U.S. Cl. CPC G06N 10/40

(57) ABSTRACT

A confinement apparatus includes a plurality of chips. Each chip of the plurality of chips are positioned at least partially on a first plane and adjacent to at least another one of the plurality of chips such that a distance between them is within 20 micrometer (μm) of each other. The plurality of chips are arranged such that at least one open area is formed on the plane and between at least two of the plurality of chips. The at least one open area extends a distance of at least 100 μm between a smallest distance between the at least two of the plurality of chips.

### CROSS-REFERENCE TO RELATED APPLICATIONS

This application claims priority to and the benefit of U.S. Provisional Application No. 63/609,764, filed Dec. 13, 2023, the contents of which are hereby incorporated by reference in its entirety.

### TECHNICAL FIELD

Various embodiments relate to quantum object confinement apparatuses. For example, various embodiments relate to a quantum object confinement apparatus having a plurality of chips arranged such that an open area is formed between at least two of the chips.

### BACKGROUND

The tiling of quantum object traps has long been recognized as an enabler for scaling. Existing methods of tiling quantum object traps include placing identical traps side-by-side in an arrayed manner. This arrayed arrangement of traps results in a one-hundred percent fill factor with a minimal amount of edge space that may be used for other components, such as input and/or output devices or photonic components. Additionally, this existing tiling arrangement may result in a long and/or lossy routing traces for optical and/or electrical signals, which may also increase power consumption. Also, this existing tiling arrangement has a relatively small footprint, which may not provide a sufficiently sized area for an ASIC to be mounted under the traps, which may be desirable.

The inventors have identified these and other numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include systems and apparatuses to provide for improved quantum object confinement.

In various aspects, a confinement apparatus includes a plurality of chips. Each chip of the plurality of chips may be positioned at least partially on a first plane, and may be positioned adjacent to at least another one of the plurality of chips such that a distance between them is within 20 micrometer (μm) of each other. The plurality of chips may be arranged such that at least one open area is formed on the first plane and between at least two of the plurality of chips. The at least one open area extends a distance of at least 100 μm between a smallest distance between the at least two of the plurality of chips.

In various examples, each chip of the plurality of chips has a geometric shape and a size. The geometric shape or the size of at least two chips may be different.

In various examples, each chip of the plurality of chips is configured to have a function. The function of at least two chips may be different.

In various examples, the function of at least one chip is quantum operation functions and the function of at least another chip is storage and/or sorting functions.

In various examples, each chip of the plurality of chips has a geometric shape and a size and is configured to have a function. At least a first chip may have a size that is greater than at least a second chip. The first chip may be configured to have the same function as the second chip.

In various examples, at least two chips have at least two adjacent sides that define a junction point. The junction point of at least one of the at least two chips may be positioned within at least 20 μm of the junction point of another one of the at least two chips.

In various examples, the confinement apparatus includes at least one application-specific operation chip that is positioned at least partially on a second plane, the second plane being parallel to the first plane. The at least one application-specific operation chip is mounted to at least one chip of the plurality of chips.

In various examples, the confinement apparatus includes a photonic component positioned at least partially on the first plane and within an open area of the at least one open area. The photonic component may be optically coupled to at least one of the plurality of chips.

In various examples, the confinement apparatus includes an input and/or output device positioned at least partially on the first plane and within an open area of the at least one open area.

In various examples, at least some of the plurality of chips substantially enclose at least one open area.

In various aspects, a system includes a computing entity, a quantum computer, and a confinement apparatus. The confinement apparatus may include a plurality of chips. Each chip of the plurality of chips may be positioned at least partially on a first plane, and may be positioned adjacent to at least another one of the plurality of chips such that a distance between them is within 20 micrometer (μm) of each other. The plurality of chips may be arranged such that at least one open area is formed on the first plane and between at least two of the plurality of chips. The at least one open area extends a distance of at least 100 μm between a smallest distance between the at least two of the plurality of chips.

In various examples, each chip of the plurality of chips has a geometric shape and a size. The geometric shape or the size of at least two chips may be different.

In various examples, each chip of the plurality of chips is configured to have a function. The function of at least two chips may be different.

In various examples, the function of at least one chip is quantum operation functions and the function of at least another chip is storage and/or sorting functions.

In various examples, each chip of the plurality of chips has a geometric shape and a size and is configured to have a function. At least a first chip may have a size that is greater than at least a second chip. The first chip may be configured to have the same function as the second chip.

In various examples, at least two chips have at least two adjacent sides that define a junction point. The junction point of at least one of the at least two chips may be positioned within at least 20 μm of the junction point of another one of the at least two chips.

In various examples, the confinement apparatus includes at least one application-specific operation chips that is positioned at least partially on a second plane, the second plane being parallel to the first plane. The at least one application-specific operation chips may be mounted to at least one chip of the plurality of chips.

In various examples, the confinement apparatus includes a photonic component positioned at least partially on the first plane and within an open area of the at least one open area. The photonic component may be optically coupled to at least one of the plurality of chips.

In various examples, the confinement apparatus includes an input and/or output device positioned at least partially on the first plane and within an open area of the at least one open area.

In various examples, at least some of the plurality of chips substantially enclose at least one open area.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides a schematic view of a system comprising a quantum object confinement apparatus, in accordance with an example embodiment.

FIG. 2 provides a top view of at least a portion of an example confinement apparatus, in accordance with an example embodiment.

FIG. 3A provides a top view of at least a portion of an example confinement apparatus, in accordance with an example embodiment.

FIG. 3B provides a side view of at least a portion of the example confinement apparatus of FIG. 3A, in accordance with an example embodiment.

FIG. 4 provides a top view of at least a portion of an example confinement apparatus, in accordance with an example embodiment.

FIG. 5 provides a top view of at least a portion of an example confinement apparatus, in accordance with an example embodiment.

FIG. 6A provides a close-up view of a portion of the example confinement apparatus of FIG. 5, in accordance with an example embodiment.

FIG. 6B provides a close-up view of a portion of the example confinement apparatus of FIG. 5, in accordance with an example embodiment.

FIG. 6C provides a view of a portion of a confinement apparatus, in accordance with an example embodiment.

FIG. 7 provides a top view of at least a portion of an example confinement apparatus, in accordance with an example embodiment.

FIG. 8 provides a schematic view of a controller, in accordance with an example embodiment.

FIG. 9 provides a schematic view of a computing entity, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “electrical communication” or “electrically coupled” means that an electric current and/or an electric signal are capable of making the connection between the areas specified. As used herein, the term “optical communication” or “optically coupled” means that light is capable of making the connection between the areas specified.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, terms of approximation, such as “approximately,” “substantially,” or “about,” refer to being within manufacturing or engineering tolerances. For example, terms of approximation may refer to being within a five percent margin of error.

In various scenarios, quantum objects are confined by a quantum object confinement apparatus (also referred to as a confinement apparatus herein). In various embodiments, a quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the quantum objects are ions and/or ion crystals, the confinement apparatus is an ion trap, such as a surface ion trap, Paul ion trap, and/or the like. In various other embodiments, the confinement apparatus is an apparatus configured to confine quantum objects and comprises two or more chips that are each configured for performance of a particular class of functions.

In an example embodiment, the confinement apparatus comprises one or more sorting chips configured for performance of a class of functions referred to herein as sorting and/or storing functions (also referred to herein as sorting functions). In various embodiments, sorting and/or storing functions include sorting quantum objects. For example, quantum objects may be sorted to change the order or positioning of quantum objects in a string/one-dimensional array, two-dimensional array, or three-dimensional array of quantum objects. In various embodiments, the sorting functions include shuttling, conveying, and/or transporting quantum objects between various chips associated with various classes of functions. For example, a sorting chip may shuttle, convey, and/or transport quantum objects between a first operation chip and a second operation chip, in an example embodiment. In various embodiments, sorting and/or storing functions include maintaining a quantum object at a location in a manner such that the quantum information stored by the quantum object is maintained and/or not likely to be disrupted. For example, the quantum object may be stored such that it is unlikely that an external field used to perform a quantum operation function on other quantum objects will affect the quantum information encoded by the quantum state of the quantum object.

In an example embodiment, the confinement apparatus comprises one or more operation chips configured for performance of a class of functions referred to herein as operation functions. In various embodiments, a function of the class of operation functions is a function that includes interacting one or more quantum objects with one another and/or an external field (e.g., magnetic field, magnetic field gradient, laser beam(s)/pulse(s), microwave(s)). For example, quantum logic gates (e.g., single qubit gates, two-qubit gates) and reading and/or measurement operations are examples of functions of the class of operation functions.

In various embodiments, the quantum objects confined by a confinement apparatus are used to perform experiments, controlled quantum state evolution, quantum computations, and/or the like. In various embodiments, the quantum objects are transported between various locations at least partially defined by the confinement apparatus and/or a system comprising the confinement apparatus. For example, a quantum object may be transported from a sorting chip configured for a sorting and/or storing function to an operation chip configured for an operation function. In various examples, a quantum object may be transported from a first chip to a second chip, the first chip and the second chip having the same function (e.g., both being sorting chips or both being operation chips). In various examples, a quantum object may be transported from a first chip to a second chip, the first chip and the second chip having a different function. One or more quantum operations may be performed on the quantum object while it is disposed within the operation chip and then the quantum object may be transported back to a sorting chip configured for a sorting and/or storing function.

Various embodiments provide (quantum object) confinement apparatuses that includes at least one sorting chip configured for a sorting and/or storing function and at least one operation chip that is configured for an operation function. In various examples, the chips that are configured for different functions are physically separated and/or distinct from one another. Such confinement apparatuses may be incorporated into a variety of trapped quantum systems, such as trapped atomic systems, QCCD-based quantum computing systems, and/or the like. An example QCCD-based quantum computing system will now be disclosed.

### Exemplary System Comprising a Quantum Object Confinement Apparatus

Various embodiments provide (quantum object) confinement apparatuses that includes at least one sorting chip configured for a sorting and storing function and at least one operation chip configured for an operation function. Such confinement apparatuses may be incorporated into a variety of trapped quantum systems, such as trapped atomic systems, QCCD-based quantum computing systems, atomic clocks, mass spectrometers (e.g., Quadrupole mass analyzers), and/or the like. An example QCCD-based quantum computing system will now be disclosed.

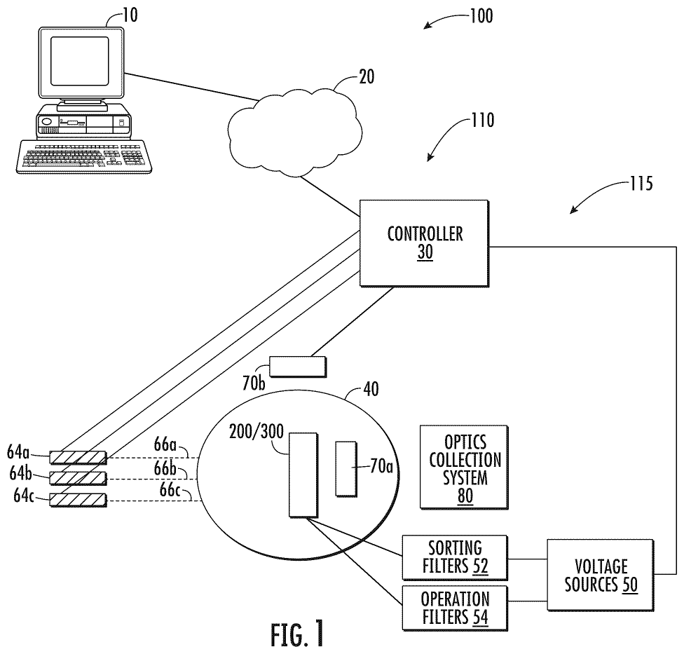

Various embodiments provide a system 100 comprising a quantum object confinement apparatus, as shown in FIG. 1. The quantum object confinement apparatus is configured to confine a plurality of quantum objects such that the respective quantum states of the quantum objects may be manipulated, evolved in a controlled manner (e.g., in accordance with a quantum circuit), and/or the like.

For example, quantum operation functions (one qubit quantum logic gates, two qubit quantum logic gates, initialization, reading and/or measurement operations, and/or the like) may be performed on quantum objects disposed within quantum operation locations defined by the confinement apparatus and/or system 100 comprising the confinement apparatus. For example, the confinement apparatus is configured to maintain one or more quantum objects at one or more operation chips configured for operation functions such that a quantum operation may be performed on the one or more quantum objects. In various embodiments, the system 100 comprising the confinement apparatus comprises one or more manipulation sources 64 (e.g., 64A, 64B, 64C) configured to provide manipulation signals (e.g., laser beams and/or pulses, microwave signals, and/or the like) such that the manipulation signals interact with one or more quantum objects disposed at the quantum operation location. In various embodiments, the system 100 comprising the confinement apparatus comprises one or more magnetic field sources 70 (e.g., 70A, 70B) configured to provide a controlled magnetic field and/or magnetic field gradient at quantum operation locations for use in performing one or more quantum operations on one or more quantum objects disposed at the quantum operation location. In various embodiments, the system 100 comprising the confinement apparatus comprises an optics collection system 80 configured to collect and/or detect light and/or photons emitted by one or more quantum objects disposed at the quantum operation location.

In an example embodiment, the system 100 comprising the confinement apparatus is and/or includes a quantum charge-coupled device (QCCD)-based quantum computer. For example, one or more of the quantum objects confined by the confinement apparatus may be used as qubits of the quantum computer.

In various embodiments, the system 100 comprises a computing entity 10 and a quantum computer 110. In various embodiments, the quantum computer 110 comprises a controller 30 and a quantum processor 115. In various embodiment, the quantum processor 115 comprises a cryostat and/or vacuum chamber 40 enclosing a confinement apparatus, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more quantum objects within the confinement apparatus. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/measurement, and/or like) on quantum objects confined by the confinement apparatus.

In an example embodiment, the one or more manipulation sources 64 each provide a manipulation signal (e.g., laser beam and/or the like) to one or more portions (e.g., quantum operation locations) of the quantum object confinement apparatus via corresponding beam path systems 66 (e.g., 66A, 66B, 66C). In various embodiments, at least one beam path system 66 comprises a modulator configured to modulate the manipulation signal being provided to the confinement apparatus via the beam path system 66. In various embodiments, the manipulation sources 64, active components of the beam path systems 66 (e.g., modulators and/or the like), and/or other components of the quantum computer 110 are controlled by the controller 30.

In various embodiments, the confinement apparatus is an ion trap, such as a surface ion trap, Paul ion trap, and/or the like. In various embodiments, the quantum objects are ions; atoms; ion crystals and/or groups; atomic crystals and/or groups; ionic, molecular, and/or multipolar molecules; quantum dots; quantum particles; groups, crystals, and/or combinations thereof (e.g., ion crystals); and/or the like. In various embodiments, the confinement apparatus is an appropriate confinement apparatus for confining the quantum objects of the embodiment.

In various embodiments, the quantum computer 110 comprises one or more voltage sources 50. For example, the voltage sources may be arbitrary wave generators (AWG), digital-analog converts (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes and/or RF electrodes) of the confinement apparatus, in an example embodiment. In various embodiments, the voltage sources 50 include sorting voltage sources that are electrically coupled to the potential generating elements (e.g., control electrodes and/or RF electrodes) of at least one sorting chip configured for a sorting and storing function of the confinement apparatus and operation voltage sources that are electrically coupled to the potential generating elements (e.g., control electrodes and/or RF electrodes) of at least one operation chip configured for an operation function of the confinement apparatus.

In various embodiments, the voltage signals generated by the voltage sources 50 are filtered before being applied to the potential generating elements (e.g., control electrodes and/or RF electrodes) of a sorting and storing chip of the confinement apparatus. In an example embodiment, the quantum computer 100 comprises sorting filters 52 and operation filters 54. The sorting filters 52 are configured to filter the voltage signals applied to the potential generating elements (e.g., control electrodes and/or RF electrodes) of one or more sorting and storing chips of the confinement apparatus. The operations filters 54 are configured to filter voltage signals applied to the potential generating elements (e.g., control electrodes and/or RF electrodes) of one or more operation chips of the confinement apparatus. In various embodiments, the sorting filters 52 and the operation filters 54 have different filter responses, different cut-off frequencies, and/or the like.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more locations defined by the confinement apparatus that has a particular magnitude and a particular magnetic field direction in the one or more locations defined by the confinement apparatus.

In various embodiments, the quantum computer 110 comprises an optics collection system 80 configured to collect and/or detect photons (e.g., stimulated emission) generated by quantum objects disposed in respective operation chips (e.g., during reading/measurement operations). The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the quantum objects. In various embodiments, the detectors may be in electronic communication with the controller 30 via one or more A/D converters 625 (see FIG. 9) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus, and/or read and/or measure a quantum (e.g., qubit) state of one or more quantum objects within the confinement apparatus. For example, the controller 30 may cause a controlled evolution of quantum states of one or more quantum objects confined by the confinement apparatus to execute a quantum circuit and/or algorithm. For example, the controller 30 may read and/or detect quantum states of one or more quantum objects within the confinement apparatus at one or more points during the execution of a quantum circuit. In various embodiments, the quantum objects confined by the confinement apparatus are used as qubits of the quantum computer 110.

### Exemplary Quantum Object Confinement Apparatus

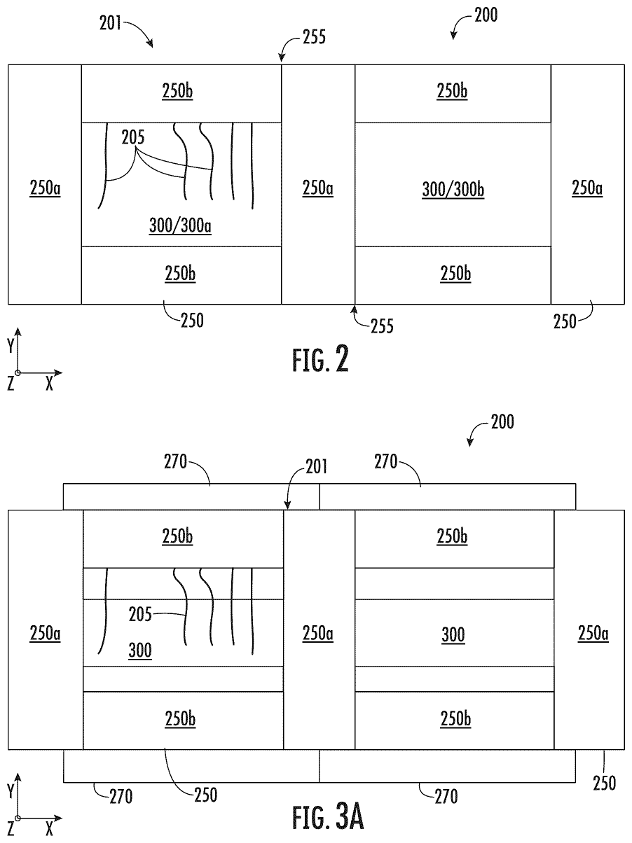

FIG. 2 provides a top view of at least a portion of an example confinement apparatus 200 that may be used to confine one or more quantum objects. The confinement apparatus 200 can define an X direction, a Y direction that is orthogonal to the X direction, and a Z direction that is orthogonal to the X direction and the Y direction. The confinement apparatus 200 can include a plurality of chips 250. Each chip 250 of the plurality of chips 250 can be positioned at least partially on a first plane that is defined by the X direction and the Y direction. In various examples, and as will be explained further, the confinement apparatus 200 can include at least one application-specific operation chips 270 that is stacked on or below the plurality of chips 250.

Each chip 250 can be configured for performance of a function. For example, one or more sorting chips 250a can be configured for the performance of sorting and storing functions. In various examples, one or more operation chips 250b can be configured for the performance of quantum operation functions. In various examples, at least one chip 250 of the plurality of chips 250 is configured for the performance of a different function than another one of the plurality of chips 250. Configuring at least one of the chips 250 to be configured for the performance of a different function than another one of the plurality of chips 250 has various benefits. For example, chips 250 that are configured for one function may have different design and fabrication requirements than other chips 250 that are configured for a different function. As such, chips 250 that are configured for different functions can be designed and fabricated separately, which may optimize the design, simplify the fabrication, and increase manufacturing yield of the chips 250.

Each of the plurality of chips 250 can be positioned adjacent to at least another one of the plurality of chips 250. For example, each of the plurality of chips 250 can be positioned in close proximity to at least another one of the plurality of chips 250 to allow a quantum object to travel between the adjacent chips 250. The distance that may allow the quantum object to travel between two chips 250 may be 20 micrometer (μm) or less, such as 15 μm or less, such as 10 μm or less, such as 5 μm or less. In various examples, when the distance between adjacent chips 250 is greater than zero, a small space 255 may be defined between the adjacent chips 250. The small space 255 can be equal to or less than the distance that may allow the quantum object to travel between the two adjacent chips 250 (i.e., 20 μm or less, such as 15 μm or less, such as 10 μm or less, such as 5 μm or less).

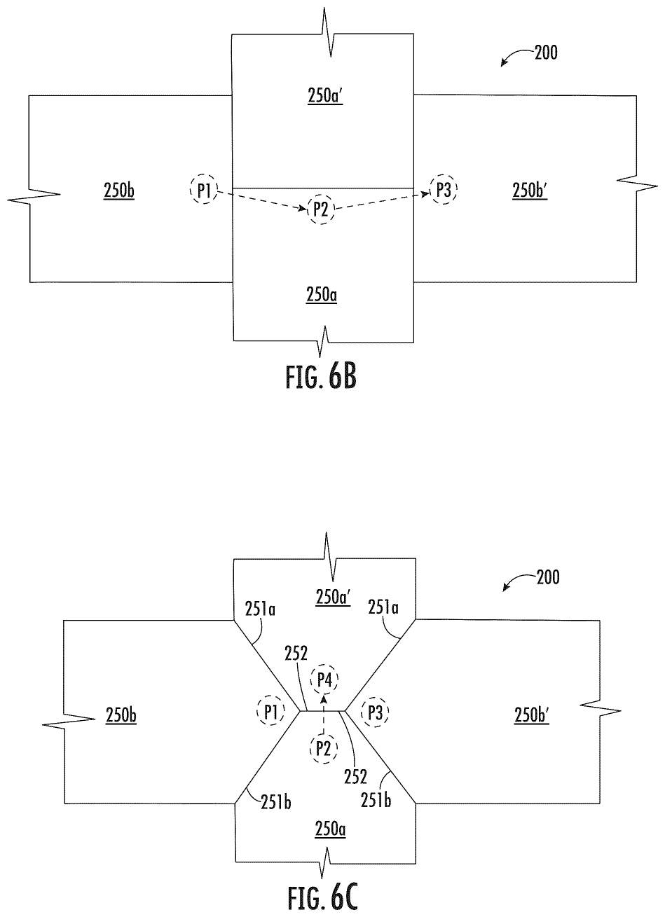

Each chip 250 of the plurality of chips 250 can have a geometric shape defined along the first plane (i.e., as viewed from the Z direction) and a size, such as an area defined along a surface of the respective chip 250 that extends parallel to the first plane. In various examples, the geometric shapes and/or the sizes of at least two chips 250 are different. In various examples, and as depicted in FIG. 2, all chips 250 have a rectangular shape but at least one chip 250, such as at least one sorting chip 250a, can have a size that is greater than at least another one chip 250, such as at least one operation chip 250b. In various examples, the geometric shape and/or the size of at least two chips that have the same function is different. For example, at least one sorting chip 250a can have a size that is greater than at least another sorting chip 250a. In various examples, at least one operation chip 250b can have a size that is greater than at least another operation chip 250b. The shapes of each chip 250 may be square, rectangular, triangular, pentagonal, hexagonal, to name a few examples. In various examples, and as will be discussed further, at least one chip 250 can have at least two adjacent sides that define a junction point 252 (FIG. 6A).

In various examples, each chip 250 that is configured to have the same function also has the same approximate geometric shape and approximate size. For example, the sorting chips 250a of the confinement apparatus 200 can all have the same approximate geometric shape and approximate size and the operation chips 250b can all have the same approximate geometric shape and approximate size, but the sorting chips 250a can have a different size and/or geometric shape than the operation chips 250. As used herein, the terms “approximate geometric shape” and “approximate size” refers to the geometric shapes and sizes being within manufacturing or engineering tolerances, such as within 2 mil, such as within 1 mil.

In various examples, each chip 250 can be distinct and/or separate from the other chips 250 of the plurality of chips 250. For example, each chip 250 can comprise a substrate that is distinct and/or separate from the substrates of other chips 250. In various examples, each chip 250 can include potential generating elements such as control electrodes and/or radio frequency electrodes that are patterned and/or formed on the respective chips. These potential generating elements of each chip 250 may not be physically connected to the potential generating elements of other chips 250 in the plurality of chips.

In various examples, the plurality of chips 250 are spaced and arranged such that at least one open area 300 is formed on the first plane defined by the X direction and the Y direction. The open area 300 may be defined between at least two of the plurality of chips 250. The at least one open area 300 can extend, in at least one dimension, a distance of at least 15 μm, such as at least 100 μm, such as at least 1 millimeter (mm), such as at least 1 centimeter (cm), such as at least 2 cm, such as at least 3 cm between a smallest distance between at least two of the plurality of chips 250. In various examples, and as depicted in FIG. 2, at least some of the plurality of chips 250 may substantially enclose at least one open area 300 on the first plane such that any portion not enclosed is less than 20 μm (i.e., the small spacing 255 between adjacent chips). Stated differently, with the exception of the small spacing 255 between adjacent chips, the plurality of chips 250 completely enclose the at least one open area 300 on the first plane, in various examples. As will be discussed further, positioning the chips 250 to form the open area 300 has various benefits. For example, providing an open area 300 may allow sufficient space and/or footprint for other components of the confinement apparatus 200, such as I/O devices 205, application-specific operation chips 270, quantum object loading chips 250d, and photonic components 260 to fit within the open area 300 and/or confinement apparatus 200.

In various examples, the confinement apparatus 200 can include a plurality of open areas 300, such as at least a first open area 300A and a second open area 300B. The first open area 300A and the second open area 300B may be distinct from one another. For example, the first open area 300A and the second open area 300B may be divided by at least one chip 250.

In various examples, the confinement apparatus 200 may include at least one input and/or output device (“I/O device”) 205 positioned within at least one open area 300 and positioned at least partially on the first plane. The at least one I/O device 205 can be electrical I/O device(s), radio frequency (RF) I/O device(s), optical I/O device(s), or a combination of different types of I/O devices. Each electrical I/O device can be configured to be in electrical communication with one or more chips 250 on the first plane such that electric current and/or electric signals can be transferred to the one or more chips 250. Each RF I/O device can be configured to be in radio frequency communication with one or more chips 250 on the first plane such that a RF signal can be transferred to the one or more chips 250. Each optical I/O device can be configured to be in optical communication with one or more chips 250 on the first plane such that optical signals or photons can be transferred to the one or more chips 250.

As will be appreciated, providing at least one I/O device 205 within the open area 300 and in electrical or optical communication with one or more chips 250 has various benefits over traditional tiled matrix configurations. For example, wire bonds for electrical I/O devices 205 may require bond pads along the edge of a chip 250. Optical fibers or “photonic wire bonds” for optical I/O devices 205 may require waveguide input couplers at the edge of a chip 250. However, if the chips 250 are arranged in a traditional tiled matrix configuration, most edges are no longer accessible for I/O devices 205. The confinement apparatus of the present disclosure may provide more edges to be accessible for I/O devices 205 and other components. Additionally, optical I/Os may require a clear optical path from the input fiber to the chip 250. This may require the optical input to come from above the chip 250 when arranged in a traditional tiled matrix configuration, which may require more complex connection and may result in lower-efficiency coupling. The confinement apparatus 200 of the present disclosure provides for an increased number of edges that are accessible to each chip 250 for a clear optical path from an input fiber.

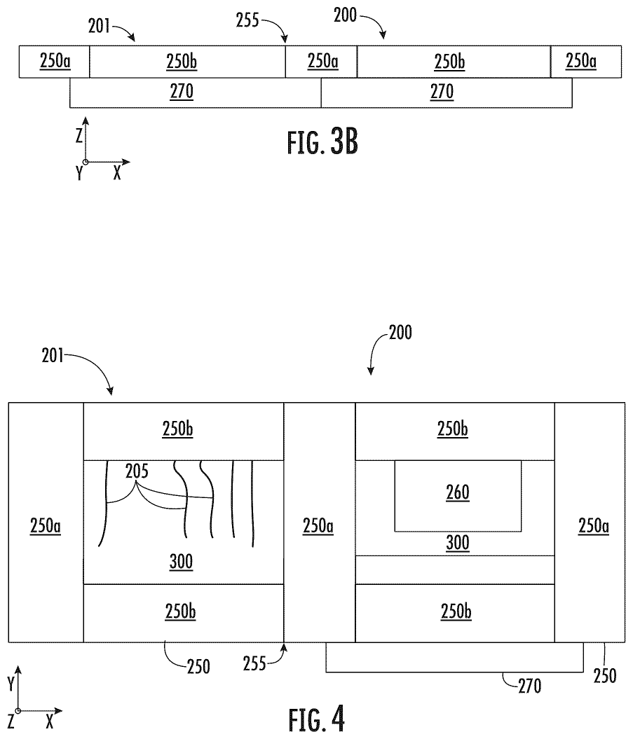

FIG. 3A provides a top view of at least a portion of an example confinement apparatus 200 that may be used to confine one or more quantum objects. In various examples, at least one application-specific operation chips 270 can be positioned at least partially on a second plane that is defined by the X direction and the Y direction. The second plane can be parallel to the first plane, which is also defined by the X direction and the Y direction. The at least one application-specific operation chips 270 that is positioned on the second plane can be mounted to at least one chip 250 of the plurality of chips 250 on the first plane. The at least one application-specific operation chips 270 that is positioned on the second plane may comprise or be an application specific integrated circuit (ASIC).

As will be appreciated, application-specific operation chips 270 that are or comprise an ASIC may be required to control the confinement apparatus 200, depending on the complexity or size of the confinement apparatus 200. The application-specific operation chips 270 may need to be located near the plurality of chips 250, and a desirable configuration may be for the application-specific operation chips 270 to be stacked directly beneath or on top of the plurality of chips 250. However, most traditional tiled matrix configurations arrangements may require the application-specific operation chips 270 to be the same size as, or smaller than, the tiled matrix configuration of chips 250 so that the application-specific operation chips 270 can be stacked with the set 201 of plurality of chips 250. Currently, most application-specific operation chips 270, which may include or be ASICs, are larger than the traditional tiled matrix configuration traps. As such, the arrangement of the present disclosure that includes open areas 300 has the benefit of increasing a footprint of a set 201 of chips 250 within the confinement apparatus 200, which may result in ample room for the application-specific operation chips 270 to fit below, or on top of, a set of chips 250.

FIG. 3B provides a side view of at least a portion of the confinement apparatus 200 of FIG. 3A. As discussed, and as depicted in FIG. 3B, the confinement apparatus 200 can include at least one application-specific operation chips 270, that is stacked below a set 201 of chips 250. In various examples, the at least one application-specific operation chip 270 can be stacked on top of a set 201 of chips 250.

FIG. 4 provides a top view of at least a portion of an example confinement apparatus 200 that may be used to confine one or more quantum objects. The confinement apparatus 200 may include at least one component 260. The at least one component 260 may a photonic component that is optically coupled to at least one of the plurality of chips 250 of the confinement apparatus 200. The at least one component 260 may be positioned within an open area 300 of the confinement apparatus 200 or on an edge of the confinement apparatus 200. In various examples, the at least one component 260 is a photonic component that is a light source, such as a laser, a photonic interposer, active photonics, a chip with an on-chip light source, to name a few examples. As will be appreciated, positioning a component 260 within an open area 300 of the confinement apparatus 200 has various benefits. For example, incorporating the open area 300 allows for an increase in edge space, which allows for more components, such as components 260 and I/O devices 205, to be positioned on or near the edges of the chips 250. The components that are positioned on or near the edges of chips 250 are on the same plane as those chips 250, which is less complex than if those components were positioned above or below the plurality of chips 250.

In various examples, the at least one component 260 may be an electronic component that is electrically coupled to at least one of the plurality of chips 250 of the confinement apparatus 200. The at least one component 260 may be any type of component that can be used within the confinement apparatus 200. The component 260 that is an electronic component may be positioned within an open area 300 of the confinement apparatus 200 or on an edge of the confinement apparatus 200.

In various examples, the at least one component 260 may be a quantum object loading chip. The component 260, when configured as a quantum object loading chip may be configured to load one or more quantum objects in, for example, a linear chain. In various examples, one or more quantum objects, such as ytterbium (Yb+) ions, are loaded into the quantum object loading chip by a photoionization of neutral ytterbium atoms from an atomic beam. In various examples, the quantum object loading chip may be positioned within an open area 300 of the confinement apparatus 200 or on an edge of the confinement apparatus 200. As will be appreciated, positioning a quantum object loading chip within an open area 300 of the confinement apparatus 200 has various benefits.

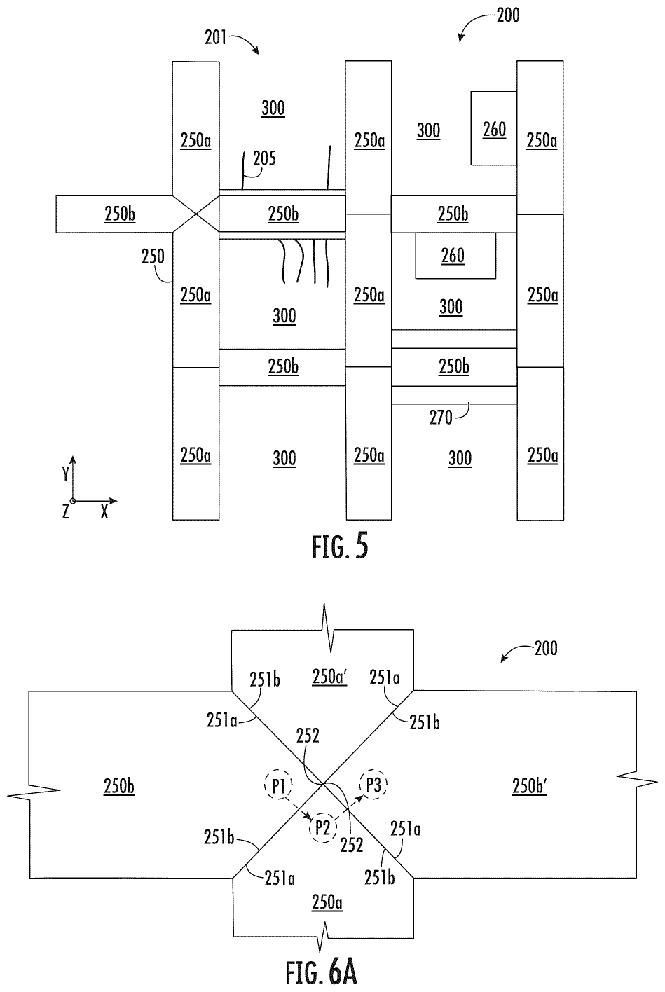

FIG. 5 provides a top view of at least a portion of an example confinement apparatus 200 that may be used to confine one or more quantum objects. In various examples, at least some of the chips 250 can have at least two sides that form a right angle to each other. For example, at least some of the chips 250 can have four sides that form a square or rectangle shape. At least some of the chips 250 that have at least two sides that form a right angle can have those sides positioned proximate to another one of the chips 250 that also have at least two sides that form a right angle. For example, at least some chips 250 that have at least two sides that form a right angle, such as square or rectangle shaped chips, can be “butted up” against another chip 250 that has at least two sides that form a right angle. In various examples, and as will be explained further, some of the chips 250 may have five or more sides.

FIG. 6A provides a close-up view of a portion of the example confinement apparatus 200 of FIG. 5. In various examples, at least one chip 250 can have at least two adjacent sides, such as a first side 251a that is adjacent to a second side 251b. Each first side 251a and second 251b may define a right angle, an acute angle, or an obtuse angle. Each of the at least two adjacent sides 251a,b can define a junction point 252. The junction point 252 can be the area where the at least two adjacent sides 251a,b intersect. The junction points 252 of at least two of the plurality of chips 250 can be positioned in close proximity to each other. For example, the junction points 252 of at least two of the plurality of chips 250 can be positioned in close proximity to each other with an industry-standard technique, such as pick and place positioning, and/or securing using an epoxy.

In various examples, and as depicted in FIG. 6A, more than two, such as three or four, junction points 252 of different chips 250 may be positioned in close proximity to each other so that the quantum object may travel between at least one chip 250 to at least another chip 250. For example, and with reference to FIG. 6A, four junction point 252 of four different chips 250a, 250b, 250a′, 250b′ may be positioned in close proximity to each other so that the quantum object may travel from one of the chips 250 to an adjacent chip 250 via the sides 251. Still referring to FIG. 6A, at least two of the chips 250b, 250b′ may be positioned opposed to each with at least one intervening chip 250a positioned between the at least two chips 250b, 250b′. For a quantum object to travel from the first chip 250b to the second chip 250b′, the quantum object may travel from a first area P1 on the first chip 250b, to a second area P2 on the intervening chip 250a, to a third area P3 on the second chip 250b′.

Positioning the junction points 252 of different chips 250 in close proximity to each other has various benefits. For example, and as will be appreciated, this configuration may reduce the distance a quantum object must travel, to travel from one of the chips 250 to another chip 250. For example, FIG. 6B depicts an example embodiment where there are no junction points in close proximity to each other. As can be seen, the distance that a quantum object, such as an ion, must travel, to travel from a first chip 250b to a second chip 250b′ is greater in the FIG. 6B example than the example provided in FIG. 6A.

FIG. 6C provides a close-up view of a portion of the example confinement apparatus 200 of FIG. 5. In various examples, a portion of at least two chips 250a, 250a′ may be trapezoid shaped and may be positioned opposed to each other and in close proximity to each other. For example, the shorter base of the trapezoid shape of the first chip 250a may define a junction 252 that is positioned in close proximity to a junction 252 defined by an adjacent chip 250a′. As will be appreciated, with this configuration, a quantum object may directly travel from a point P2 on the first chip 250a to a point P4 on the second chip 250a′, which may be beneficial because it may reduce the distance that the quantum object must travel. Additionally, the quantum object may not need to travel through an intervening chip 250b, which may be beneficial.

The configurations discussed in reference to FIGS. 6A-6C have various benefits. For example, the configuration of FIG. 6A may decrease a likelihood that one of the chips 250 may become misaligned relative to another one of the chips 250 when the chips 250 are being assembled. For example, the configuration of FIG. 6A features junction points 252 that are positioned in close proximity to each other when the chips 250 are assembled together. This creates a puzzle-like assembly process where the degrees of freedom of potential locations for each chip are minimized as compared to other configurations, such as the configuration of FIG. 6B. As can be seen in the example of FIG. 6B, the chips 250b 25b′ may be more easily “shifted” relative to chips 250a, 250a′ during assembly. As such, the configuration of FIG. 6A may simplify the assembly process or reduce the likelihood that the chips may be mispositioned or misaligned with other chips, as compared to other configurations.

The configurations of FIGS. 6A through 6C may increase the quantity of quantum objects that may be transported from one chip 250 to an adjacent chip 250 in parallel, depending on where the quantum object is being transported from and to. For example, the configurations depicted in FIGS. 6A and 6C may allow for more quantum objects to be transported in parallel from chip 250a to chip 250b′ than the configuration depicted in FIG. 6B. The configurations of FIGS. 6A and 6C may allow more quantum objects to be transported in parallel in this scenario because the lengths of the sides 251 of chip 250a chip 250b′ that are positioned in close proximity to each other, which the quantum objects are to traverse across, are greater in these examples than the FIG. 6B example.

Similarly, the FIG. 6B example may allow more quantum objects to be transported in parallel from chip 250a to chip 250a′ than the configurations depicted in FIGS. 6A and 6C. The FIG. 6B example may allow more quantum objects to be transported in parallel in this scenario because the lengths of the sides 251 of chip 250a and chip 250a′ that are positioned in close proximity, which the quantum objects are to traverse across, are greater in these examples than the example of FIGS. 6A and 6C.

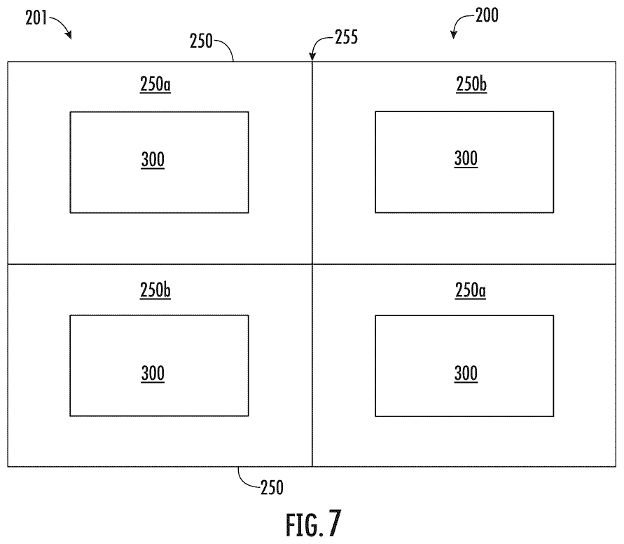

FIG. 7 provides a top view of at least a portion of an example confinement apparatus 200 that may be used to confine one or more quantum objects. In various examples, at least one chip 250 of the plurality of chips 250 can be fabricated on a wafer. An open area 300 can be formed on the chip 250 by an etching process to remove the material on the chip 250. Each of the plurality chips 250 may then be positioned in close proximity to at least another one of the plurality of chips 250 to allow a quantum object to travel between the chips 250. Other components of the confinement apparatus 200 can be positioned within the at least one open area 300 formed on the at least one chip 250 or placed at the edge of the set 201 of chips 200. For example, at least one quantum object loading chip 260, application-specific operation chips 270, and/or I/O devices 205 can be positioned within the at least one open area 300 or at the edge of the set 201 of chips 200.

In various examples, a detection apparatus (not depicted), such as a detection cloud, can be positioned in close proximity to the confinement apparatus 200. For example, the detection apparatus can be positioned within 300 um from the confinement apparatus 200, such as at least 50 μm and up to 1 mm away from the confinement apparatus 200. The detection apparatus may be positioned on the same plane as the confinement apparatus 200 or on a different plane than the confinement apparatus. In various examples, one or more photonic components 260 and/or one or more I/O devices 205 are positioned on the same plane as the detection apparatus.

### Exemplary Controller

Various embodiments provide systems comprising confinement apparatuses that include one or more sorting chips configured for the performance of sorting and storing functions and one or more operation chips configured for the performance of quantum operation functions. In an example embodiment, the system is a quantum charge-coupled device (QCCD)-based quantum computer 110 or other quantum computer. In various embodiments, the system (e.g., quantum computer 110) further comprises a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), active components of beam path systems 66 (e.g., 66A, 66B, 66C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more quantum objects confined by the confinement apparatus, and/or read and/or detect a quantum state of one or more quantum objects confined by the confinement apparatus.

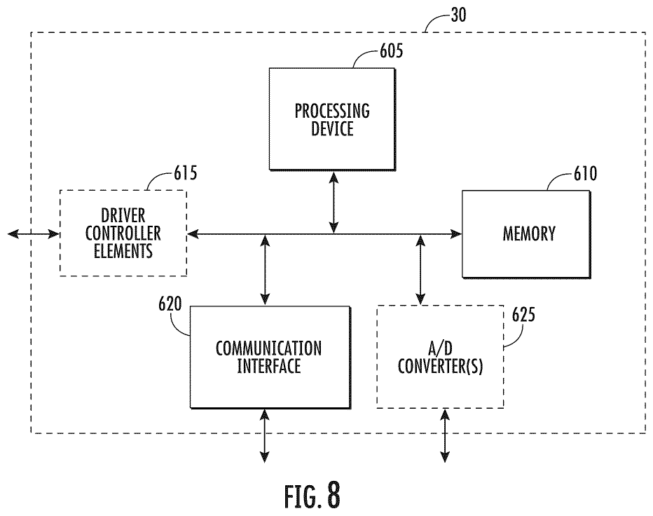

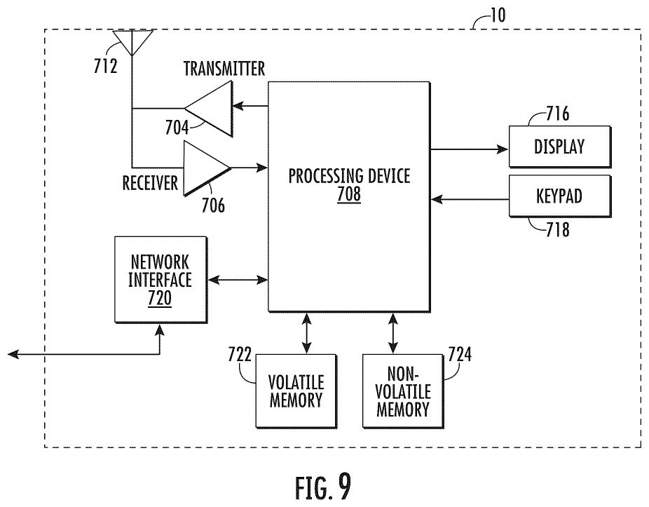

As shown in FIG. 8, in various embodiments, the controller 30 may comprise various controller elements including one or more processing devices 605, memory 610, driver controller elements 615, a communication interface 620, analog-digital converter elements 625, and/or the like. For example, the one or more processing devices 605 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 605 of the controller 30 comprises a clock and/or is in communication with a clock. In various embodiments, this clock defines the clock cycles of the system.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for controlling one or more components of the quantum computer 110 (e.g., voltages sources 50, manipulation sources 64, magnetic field sources 70, and/or the like) to cause a controlled evolution of quantum states of one or more quantum objects, detect and/or read the quantum state of one or more quantum objects, and/or the like.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a manipulation source 64. In various embodiments, the drivers may be laser drivers; vacuum component drivers; drivers for controlling the flow of current and/or voltage applied to RF, control, and/or other electrodes (e.g., shim electrodes and/or the like) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages, electrical signals, and/or optical signals to the input and/or output devices. In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 625 configured to receive signals from one or more detectors, optical receiver components, calibration sensors, and/or the like.

In various embodiments, the controller 30 may comprise a communication interface 620 for interfacing and/or communicating with one or more computing entities 10. For example, the controller 30 may comprise a communication interface 620 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Exemplary Computing Entity

FIG. 9 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 9, a computing entity 10 can include an antenna 712, a transmitter 704 (e.g., radio), a receiver 706 (e.g., radio), and a processing device 708 that provides signals to and receives signals from the transmitter 704 and receiver 706, respectively.

The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X(1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 720 configured to communicate via one or more wired and/or wireless networks 20.

The computing entity 10 may also comprise a user interface device comprising one or more user input/output interfaces (e.g., a display 716 and/or speaker/speaker driver coupled to a processing device 708 and a touch screen, keyboard, mouse, and/or microphone coupled to a processing device 708). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 718 (hard or soft), a touch display, voice/speech or motion interfaces, scanners, readers, or other input device. In embodiments including a keypad 718, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A confinement apparatus comprising:
a plurality of chips,
wherein each chip of the plurality of chips:
is positioned at least partially on a first plane, and
is positioned adjacent to at least another one of the plurality of chips such that a distance between them is within 20 micrometer (μm) of each other,
wherein the plurality of chips are arranged such that at least one open area is formed on the first plane and between at least two of the plurality of chips, and
wherein the at least one open area extends a distance of at least 100 μm between a smallest distance between the at least two of the plurality of chips.

2. The confinement apparatus of claim 1, wherein each chip of the plurality of chips has a geometric shape and a size, and wherein the geometric shape or the size of at least two chips are different.

3. The confinement apparatus of claim 1, wherein each chip of the plurality of chips is configured to have a function, and wherein the function of at least two chips is different.

4. The confinement apparatus of claim 3, wherein the function of at least one chip is quantum operation functions and the function of at least another chip is storage and/or sorting functions.

5. The confinement apparatus of claim 1, wherein each chip of the plurality of chips has a geometric shape and a size and is configured to have a function, wherein at least a first chip has a size that is greater than at least a second chip, and wherein the first chip is configured to have the same function as the second chip.

6. The confinement apparatus of claim 1, wherein at least two chips have at least two adjacent sides that define a junction point, and wherein the junction point of at least one of the at least two chips is positioned within at least 20 μm of the junction point of another one of the at least two chips.

7. The confinement apparatus of claim 1, further comprising at least one application-specific operation chip that is positioned at least partially on a second plane, wherein the second plane is parallel to the first plane, and wherein the at least one application-specific operation chip is mounted to at least one chip of the plurality of chips.

8. The confinement apparatus of claim 1, further comprising a photonic component positioned at least partially on the first plane and within an open area of the at least one open area, wherein the photonic component is optically coupled to at least one of the plurality of chips.

9. The confinement apparatus of claim 1, further comprising an input and/or output device positioned at least partially on the first plane and within an open area of the at least one open area.

10. The confinement apparatus of claim 1, wherein at least some of the plurality of chips substantially enclose at least one open area.

11. A system comprising:
a computing entity;
a quantum computer; and
a confinement apparatus, wherein the confinement apparatus comprises:
a plurality of chips,
wherein each chip of the plurality of chips:
is positioned at least partially on a first plane, and
is positioned adjacent to at least another one of the plurality of chips such that a distance between them is within 20 micrometer (μm) of each other,
wherein the plurality of chips are arranged such that at least one open area is formed on the first plane and between at least two of the plurality of chips, and
wherein the at least one open area extends a distance of at least 100 μm between a smallest distance between the at least two of the plurality of chips.

12. The system of claim 11, wherein each chip of the plurality of chips has a geometric shape and a size, and wherein the geometric shape or the size of at least two chips are different.

13. The system of claim 11, wherein each chip of the plurality of chips is configured to have a function, and wherein the function of at least two chips is different.

14. The system of claim 13, wherein the function of at least one chip is quantum operation functions and the function of at least another chip is storage and/or sorting functions.

15. The system of claim 11, wherein each chip of the plurality of chips has a geometric shape and a size and is configured to have a function, wherein at least a first chip has a size that is greater than at least a second chip, and wherein the first chip is configured to have the same function as the second chip.

16. The system of claim 11, wherein at least two chips have at least two adjacent sides that define a junction point, and wherein the junction point of at least one of the at least two chips is positioned within at least 20 μm of the junction point of another one of the at least two chips.

17. The system of claim 11, further comprising at least one application-specific operation chip that is positioned at least partially on a second plane, wherein the second plane is parallel to the first plane, and wherein the at least one application-specific operation chip is mounted to at least one chip of the plurality of chips.

18. The system of claim 11, further comprising a photonic component positioned at least partially on the first plane and within an open area of the at least one open area, wherein the photonic component is optically coupled to at least one of the plurality of chips.

19. The system of claim 11, further comprising an input and/or output device positioned at least partially on the first plane and within an open area of the at least one open area.

20. The system of claim 11, wherein at least some of the plurality of chips substantially enclose at least one open area.
